(19) United States
(12) Patent Application Publication
(10) Pub. No.: US 2006/0231759 A1
(43) Pub. Date: Oct. 19, 2006

(54) Uniform broad ion beam deposition

(76) Inventor: Mervyn Howard Davis, West Sussex (GB)

Correspondence Address: HODGSON RUSS LLP, ONE M & T PLAZA, SUITE 2000, BUFFALO, NY, 14203-2391, US

(21) Appl. No.: 10/479,266

(22) PCT Filed: May 29, 2002
(86) PCT No.: PCT/GB02/02544

§ 371 Date: Nov. 26, 2004

(30) Foreign Application Priority Data
Jun. 1, 2001 (GB) 0113368.5

(51) Int. Cl. G21K 7/00

(52) U.S. Cl. 250/311

(57) ABSTRACT

Apparatus for the generation of a plurality of ion beams for use in vacuum sputtering methods is disclosed comprising: a discharge chamber, defined by a plasma confinement vessel, for generation of a plasma therein; and a plurality of facets located on the discharge chamber, each facet comprising acceleration and extraction means for extracting ions from the plasma in the discharge chamber in an ion beam.

The present invention relates to apparatus for use in vacuum sputtering. More particularly, it relates to ion beam generation apparatus for the generation of a plurality of ion beams which may be used to bombard a target in a vacuum sputtering apparatus for use in the production of multi-layer thin film structures. The present invention also relates to a method for the deposition of multi-layer thin films on a substrate.

In general, vacuum sputtering involves bombarding a target, within a vacuum chamber, with a beam of ions generated in a plasma.

Ion beams have been used for many years in the production of components in the micro-electronics industry and magnetic thin film devices used for the storage of data. They are also used in the precision optical coating industry. In a typical ion beam source (or ion gun) a plasma is produced by admitting a gas or vapour to a low pressure discharge chamber containing a heated cathode and an anode which serves to remove electrons from the plasma and to give a surplus of positively charged ions which pass through a screen grid or grids into a target chamber which is pumped to a lower pressure than the discharge chamber. Ions are formed in the discharge chamber by electron impact ionisation and move within the body of the ion gun by random thermal motion. The plasma will thus exhibit positive plasma potential which is higher than the potential of any surface with which it comes into contact. The grids may include an array of apertures such that beamlets are formed which together form the ion beam.

The grid may be a multigrid system. In a multigrid system the first grid encountered by the ions is usually positively biased whilst the second grid is negatively biased. A further grid may be used to decelerate the ions emerging from the ion source so as to provide a collimated beam of ions having more or less uniform energy.

Hence, in a typical ion gun an ion arriving at a multiaperture extraction grid assembly first meets a positively biased grid. Associated with the grid is a plasma sheath. Across this sheath is dropped the potential difference between the plasma and the grid. This potential will attract ions in the sheath region to the first grid. Any ion moving through an aperture in this first grid, and entering the space between the first, positively biased grid, and the second, negatively biased, grid is strongly accelerated in an intense electrical field. As the ion passes through the aperture in the second grid and is in flight to the earthed target it is moving through a decelerating field. The ion then arrives at an earthed target with an energy equal to the potential of the first, positive, grid plus the sheath potential.

Hence, a conventional ion gun comprises a source of charged particles which are accelerated through an externally applied electric field created between a pair of grids. Conventionally, for low energy ion beam production, three grids are used, the first being held at a positive potential, the second being held at a negative potential adjusted to give the best divergence, and the third, if present, at earth potential, i.e. the potential of the chamber in which the beam is produced. Beams of this nature are described in the open literature going back over 25 years.

In the accelerator system described in U.S. Pat. No. 4,447,773, a pair of spaced, parallel extraction grids have aligned pairs of holes for extracting ion beamlets. The pairs of holes are positioned so that the beamlets converge and the merged beamlets are accelerated by an accelerator electrode downstream of the extraction grid pair. The extraction grids are formed with numerous small holes through which beamlets of ions can pass and are maintained at a potential difference of a few hundred volts. The accelerator electrode has a single hole, which is slightly greater in height than the height of the matrix of holes in the extraction grids, and is maintained at a much lower potential for accelerating the converged ion beam emerging from the extraction grid pair.

An extensive introduction to and prior art review of ion beam technology is provided in EP-B-0462165. An improved ion gun is described in WO98/15150 which is incorporated herein by reference.

Howsoever formed, the ion beam bombardment of the target causes atoms, and/or clusters of atoms, of the target material to be ejected therefrom. These ejected atoms are known as sputtered atoms. A substrate is positioned in the vacuum chamber in the pathway of the sputtered atoms, such that sputtered atoms are deposited onto the surface of the substrate, such that a thin layer is built up on the substrate. Suitable substrates include ceramics, metals, plastics materials, glass and semiconductor wafers, for example silicon wafers. This technique enables ultra thin films, such as those having a thickness of approximately 0.5 nm, to be achieved. The technique may also be used to produce thicker films if required

The ability to produce thin films is important in many fields, and particularly in the telecommunications industry. Although there are various techniques which can be employed to produce thin films, the vacuum sputtering technique has several advantages over other methods, as the films produced often exhibit superior characteristics than those produced by conventional means. For example, the adhesive force formed between the thin film and the substrate is stronger when the film is formed by vacuum sputtering.

For some applications, a multi-layer thin film structure may be required and the vacuum sputtering technique described above is particularly suitable for producing these structures. This is particularly the case where the films are composed of materials having high melting points.

Recently the need for telecommunication services has increased dramatically as the requirement to carry not only voice but also data such as faxes, emails and the like has increased. This has led to a corresponding increase in the demand for capacity. Further, telecommunications carriers are increasingly being asked to provide guarantees as to the availability of their services. In order to ensure that they can meet these guarantees, the telecommunication carriers may have to have greater capacity in their system than is actually required to run the services at any one time.

A further pressure on the telecommunication companies to increase their capacity levels has been the recent introduction of the use of erbium doped fibre amplifiers (EDFA's) which has facilitated the introduction of broadband optical communication systems.

When a signal is transmitted through an optical fibre at a single wavelength it is said that a “single channel” is used. One proposed solution to the problem of capacity is to use the technique of wavelength division multiplexing (WDM). WDM allows a single fibre to be used for the transmission of multiple channels of information. This is done by simultaneously passing different wavelengths of light, usually laser light along the fibre.

Since every different wavelength of laser light can carry information which is different to that carried by other wavelengths, it is possible to transmit different wavelengths of light, each carrying different information, through the fibre such that the fibre is carrying a plurality of channels. Over time, the number of channels which can be carried by a single fibre has increased as technology has developed. Initially it was only possible to carry a single channel, this then increased to eight, to sixteen and subsequently to thirty-two. It is believed that in the future an increase from 32 to 64, to 128, and even to 256 channels per fibre will be possible.

Generally, in order to successfully pass the differing wavelengths along the fibre, multiplexing filters are used to discriminate between the different wavelengths of laser light. These filters are complex multi-layer structures which consist principally of alternating laminations of high and low refractive index transparent materials. Multiplexing filters are generally interference filters which are capable of discriminating light having wavelengths which differ by a value in the order of 1 nm or less.

When WDM provides the increased channel capacity described above it is termed Dense Wavelength Division Multiplexing (DWDM). DWDM currently allows the throughput of a single fibre to be up to 40 gigabytes per second. DWDM technology will allow the realisation of the full bandwidth potential of modern optical fibre systems and eventually approach 10 terabytes per second.

As the WDM technique has been developed through to DWDM the demand for accuracy and precision has increased. Thus filters used to separate the wavelengths must be capable of discriminating between wavelengths differing by about 1 nm. Vacuum sputtering is therefore a useful tool in the production of these filters.

Further, in the light of the high demand for such filters, the need for high accuracy and precision must be met by a manufacturing method which is capable of implementation in mass-production.

A further problem which must be addressed is the need to be able to reproducibly manufacture filters which are capable of discriminating wavelengths to a degree of precision that varies as little as possible from a mean value of a desired wavelength. Any variation from the mean value of wavelength is commonly expressed as a percentage value in respect of non-uniformity. Thus a perfect sample with no variation from the mean is said to exhibit 100% uniformity, i.e. 0% non-uniformity. In order to achieve the lowest possible variation, the non-uniformity should be at most ±0.01% and is preferably ±0.006% in order to achieve 100 GHz filters. It is likely that superior levels of non-uniformity will be required for the production of future generations of filters which may be 50 GHz or even 25 GHz.

The manufacture of the complex structures of the multiplexing filters has always presented a challenge to manufacturers. Presently, when a multi-layer structure is deposited on a substrate using vacuum sputtering techniques, a portion is not suitable for use in manufacturing the filter or other such devices. This is because known deposition techniques lack sufficient uniformity and precision of deposition to yield a usable film across the entirety of the substrate. It is therefore usually necessary to harvest the usable film. Thus, it is desirable to optimise precision in order to increase the harvestable area produced which in turn will increase the economic viability of the process.

Known vacuum sputtering apparatus suffer from various disadvantages and drawbacks. Whilst they are generally capable of producing good levels of uniformity in the deposited film thickness, this is only over a fraction of the area of the substrate. Typically the harvestable area of sufficient quality achievable will be in the order of only 1000 mm² where conventional methods are used to produce 100 Ghz filters. This results in significant wastage which in turn contributes to the high costs of these filters.

The requirement for DWDM filters to be able to separate light having very close wavelengths means that only a small area close to the centre of the substrate, or depending on the method, in an annulus around the centre, is suitable for use.

It is notable that the harvestable area of the deposited film is not dependant upon the size of the substrate upon which the film has been deposited. Typically substrates used for deposition will have a diameter of from about 100 mm to about 300 mm. Even with a large size substrate, the largest harvestable area currently achievable is approximately 1000 mm². In general, the ratio of the harvestable area to the total area of film deposited is from 1:8 for a 100 mm diameter substrate to 1:70 for a 300 mm diameter substrate, i.e. from about 12.5% down to as little as about 1.4%.

There is therefore a need to substantially increase the area over which the desired level of uniformity is achieved. Broad ion beam deposition systems are conventionally used in vacuum sputtering methods for the deposition of optical filters. Traditionally these systems employ two broad ion beam sources. The first of these sources is used to illuminate the target material such that sputtered ions may be ejected and deposited onto the substrate. This sputtering of the material from the target provides a deposition material flux. The second broad ion beam source is the etch/assist source which is directed at the substrate in order to illuminate the growing thin film of sputtered material with an energetic particle beam. Illumination of the growing film provides surface energy which modifies the structure and quality of the depositing film. The second source may also be used for cleaning cycles on the substrate prior to deposition.

UK Patent Application No. 0030538.3, which is incorporated herein by reference, describes a vacuum sputtering apparatus in which two or more ion sources are used to illuminate the target. The benefit of using this arrangement is that the ion beams emitted from the sources may be directed at different points on the target which results in improved control and manipulation of the non-uniformity of the coating on the substrate.

In any sputtering apparatus, it is important to tune the ion beam source to ensure suitable performance. One problem associated with the systems in which a plurality of ion beam sources are used is that each source must be independently controlled. It is generally a lengthy and arduous task to tune the performance of each ion beam to maximise the harvestable area that is required, for example in the production of an optical filter. Further, since in general, the beams must be adjusted such that they operate in concert, the tuning requirement is generally more than double that of tuning a single ion beam source. Whilst steps are taken to tune multiple ion beams so that they operate in concert, it will be understood that variations between the plasma generators can be difficult to compensate for. Tuning may also be required to take account of target wear and as a target is changed for one of a different material.

Where the source used is a radio frequency (r.f.) source, precise control of the r.f. input power is required which adds further to the requirement to control the source. Therefore, there is a requirement for a vacuum sputtering apparatus having a plurality of ion beams which can be readily and precisely controlled.

There is therefore a desire to produce a system which overcomes the aforementioned disadvantages and drawbacks and which, in particular, provides ion sources which may be used in a vacuum sputtering apparatus to maximise the harvestable area on a deposition target and which can be tuned efficiently.

Thus according to a first aspect of the present invention there is provided apparatus for the generation of a plurality of ion beams comprising:
a discharge chamber, defined by a plasma confinement vessel, for generation of a plasma therein; and
a plurality of facets located on the discharge chamber, each facet comprising a respective acceleration and extraction means for extracting ions from the plasma in the discharge chamber and accelerating the extracted ions out of the discharge chamber in an ion beam.

One or more of the ion beams may themselves be comprised of a number of beamlets which are formed by each acceleration and extraction means having a plurality of apertures as has been described in the prior art.

The apparatus of the present invention overcomes the aforementioned problems and will generally allow thin films to be deposited with a substantially increased area, for example between about 10000 mm² to about 30000 mm², over which a level of non-uniformity of at most ±0.01%, preferably 0.006%, is achieved. This apparatus will also enable the increased non-uniformity required for next generation filters to be achieved.

The ability to produce two or more ion beams from a single ion beam source means that the extraction arrays are all driven by a common plasma generator and thus changes in discharge current density is generally self-compensating between the beams.

Further, since there is no need for discrete plasma confinement vessels, the beams may be located in closer proximity than has been achievable heretofore which has advantages when illuminating areas of the target.

The apparatus may comprise any number of facets and each facet may be made up of a single aperture or an array of apertures. Where two beams are required, the apparatus will comprise two facets; where three beams are required three facets will be present and so on. The facets may be arranged in any suitable arrangement. Where three facets are used, they may be arranged in a triangular pattern.

The facets may be pivotably mounted on the discharge chamber. In one arrangement of the present invention, the facets may be adjusted manually. In one alternative arrangement, the facets may be adjusted automatically, such as by the use of micro-actuators, which may be piezoelectric.

Ion beams, unlike laser beams, diverge as they propagate and this behaviour makes it difficult to fully capture the whole beam on a target. Such beams are known as unsteered beams. The area of illumination of a target by an unsteered ion beam is governed by the ion beam propagation distance, the ion beam half angle divergence and the inclination of illumination. An ion beam from conventional ion bean sources, if unsteered, would typically be about 200 mm to 250 mm in width. As the diameter of a deposition target is typically about 100 mm to about 300 mm, parts of the unsteered ion beam may not actually illuminate the target and would therefore be wasted.

The use of the single ion source of the present invention minimises the control issues. However, it is preferable to vary the fluxes from the respected extractors in unison to meet the exacting requirement of constant balance between the beams.

With steering, an ion beam may be contained within a width of about 100 mm to about 150 mm. This means that all parts of the ion beam are utilised to illuminate the target. WO98/18150, which is incorporated herein by reference, describes an ion beam source, or ion gun, which has an accelerator structure, or extractor assembly, designed to allow sector steering of the ion beam which enables the areas of beam which would, under normal circumstances, miss the deposition target to be directed back towards the centre of a preferred area of the target. The beam quality and control achievable by employing such extractor assemblies allows different sectors of beam to be “mapped” on to the deposition target in order to “focus” the beam in a specific, contained area.

In order to minimise the effects of beam divergence, an extractor assembly as exemplified in WO98/18150 may be employed in one or more of the facets of the present invention. By this means each beam may be steered.

Using a “steered” ion beam obtainable from an ion beam source as exemplified in WO98/18150 allows the operator of the apparatus to tailor the “image” of the two, or more, beams on the surface of the deposition target. Each beam may be steered such that it hits a different location on the target, as the orientation of the beams is broadly adjustable. The steering within the beam is used to influence the desired shape of the image that the beam projects onto the illuminated target. Importantly, a complementary effect is seen when there is a degree of overlap between the areas of target which are illuminated by the ion beams. This effect gives exceptionally good film deposition non-uniformity and results from directing a plurality of ion beams at the deposition target.

The use of a well controlled and steered beam gives the opportunity to refine and increase the yielding area for exceptionally good film deposition uniformity. It has been found that positioning the beam in different areas of the deposition target affects the non-uniformity trends of deposition. Thin film deposition of substrates having a level of non-uniformity of at most ±0.01%, and preferably about ±0.006%, and most preferably better than ±0.006% may be possible using the technique of the present invention. The plasma is generated within the discharge chamber, by either d.c. or r.f. plasma generation means, from a gas or vapour supplied to the discharge chamber through an inlet. A typical d.c. plasma generation means produces a plasma from a gas or vapour in a low pressure discharge chamber containing a heated cathode and an anode. The r.f. plasma generation means utilises high frequency radio energy, typically at a frequency of about 1 MHZ to about 40 MHZ, which is directed into the discharge chamber. Regardless of the method of generation, electrons are removed from the gas or vapour to form the plasma.

In order to form the ion beams, magnets are typically used to trap the electrons which are readily lost from the discharge due to their high mobility. The electrons are generally trapped adjacent to the wall of the discharge chamber. In one arrangement a plurality of parallel bar magnets is arranged around the periphery of the chamber with alternating north and south poles facing the chamber. Once trapped the electrons can then be removed through the apertures or arrays of apertures in the accelerator grids present on each facet.

This apparatus is particularly used to achieve improved results in vacuum sputtering apparatus. Thus according to a second aspect of the present invention there is provided vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and
apparatus for the generation of a plurality of ion beams in accordance with the above-mentioned first aspect arranged so as to project the plurality of ion beams into the vacuum chamber so as to illuminate a respective area of the deposition target.

The substrate table is preferably rotatable and the apparatus preferably includes means for rotating the substrate table.

The deposition target may be comprised of any suitable material and will be selected to be appropriate to the end use. For example if filters are to be produced, the target material may be selected from Mg, Si, Ti, Ta, Nb, Hf, Lr and Mo. These may be present where appropriate in their elemental state or as their oxides, fluorides or other compounds. The oxides may be present as ceramic materials. Other materials which may be used as target materials include: ferromagnetic materials such as FeMn, IrMn and PtMn; high moment magnetic materials such as Ni₅₅—Fe₄₅, FeX and Fe; moderate moment magnetic material such as Ni₈₁Fe₁₉; non-magnetic materials such as Cu, Ru and Al; dielectric materials such as SiO₂ and Ta₂O₅; and ceramic materials such as Zr.

The thin film deposited upon the substrate may have a thickness of 0.5 nm or smaller. However, the thickness required will generally depend on the refractive index of the specific material and for optical filter applications in which film thicknesses are commonly quarter wave interference thickness, the thickness will be in the region of from about 150 nm to about 300 nm.

Where the substrate has a diameter of 100 mm a harvestable area approaching about 100% is achievable. For a substrate having a 300 mm diameter, a harvestable area of from about 15% up to about 43% can be obtained.

The ion beams which illuminate the deposition target are substantially circular in cross-section. Each ion beam usually strikes the surface of the deposition target or substrate at an oblique angle and hence illuminates an area which is substantially oval in shape. However, through steering of the ion beams as described above it is possible to illuminate an area of deposition target which is a different shape and is not substantially oval in shape. The areas illuminated by the ion beams on the deposition target may be discrete, they may abut each other, or they may overlap. In one embodiment, the total area illuminated by the ion beams may be of a substantially hourglass shape.

The optimum degree of overlap of the ion beams depends upon the particular application and is governed by ion beam divergence, the degree of ion beam steering, the angle of illumination and the beam propagation distance.

Where a target is illuminated with high voltage ion beams, surface charging may occur, particularly where the target is a dielectric material. This build up of charge will tend to deflect the ion beam and may also give rise to electrical arcing. In order to avoid this build up of charge, a supply of electrons may be provided to the target to effect neutralisation. Whilst the electrons may be injected from outside the ion beam columns, best results are achieved when the electrons can be provided within the ion beam columns. Thus in a preferred arrangement of the present invention, the apparatus will additionally include a neutraliser. The neutraliser may be located in the middle of the arrangement of arrays of apertures. Thus, for example, where there are three arrays of apertures arranged in a triangular orientation, the neutraliser will be located in the redundant space in the centre of the arrangement of arrays of apertures.

According to a third aspect of the present invention there is provided, a method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to the above-mentioned first aspect of the present invention so as to cause material to be sputtered from the deposition target; and
c) rotating the substrate while the deposition target is illuminated by the deposition target illuminating ion beams.

The ion beam deposition technique is not a rapid method of achieving deposition. The rate of deposition is dependent upon the ion beam power. It is known that the rate of sputtering of a target can be increased by increasing the ion beam voltage from about 1500 to about 2000 V. Whilst voltages greater than above about 2000V may be used, it is generally found that little benefit is achieved since the additional energy may cause implantation and/or heating rather than ejection from the target. Alternatively, the level of delivered current may be enhanced. However, the current available from a multi-aperture extractor assembly, is governed by the Child-Langmuir relationship and is finite.

In the present invention, the single ion source may deliver between about 400 mA and 600 mA. However, as the ion beam source apparatus of the current invention delivers a plurality of beams from a common plasma source substantially more current may be delivered than has been possible heretofore. For example, in an arrangement having two aperture arrays, from about 800 mA to about 1000 mA may be delivered and in an arrangement having three aperture arrays, from about 1200 mA to about 1500 mA may be delivered.

The alignment of the electrodes of the present invention needs to be held to close tolerances within the extractor. Further, the separation between the faces of the electrode should generally be maintained within a design tolerance. In some situations, if these parameters vary, the beam characteristics may change as the source heats. This can be important since if localised changes occur in one or more areas within an array, the global beam shape and quality may be changed.

To overcome these problems, refractory materials may be used to make the electrodes of the accelerator. In particular, molybdenum may be used.

To provide a composite combined current output of a practical usable magnitude, deposition sources are commonly about 150 mm in diameter. Thus, generally the array of apertures in each facet will be arranged within a 150 mm diameter area. The array may be of any suitable shape but generally will be circular.

Where larger areas are used, difficulties may be encountered in maintaining electrode separation. These can be addressed by the use of additional supports and separators in the extraction area. However, care will need to be taken to ensure protection of the inter-electrode, inter-grid, high voltage insulators.

In a preferred arrangements, multiple array assemblies of a standard general design which is typically no larger than 150 mm is used, and in which electrostatic steering within the individual arrays is present.

The capability of the present invention to allow, in a preferred arrangement, adjustment of each facet with respect to the plane represented by the front face of the plasma generator assembly is important. This mechanical adjustment is used to provide course directional control and the steering as described above, where present allows a fine element of control and which may compensate for inclinative effects.

In order that the invention may be clearly understood and readily carried into effect a preferred embodiment thereof will now be described, by way of example only, with reference to the accompanying drawings, wherein:

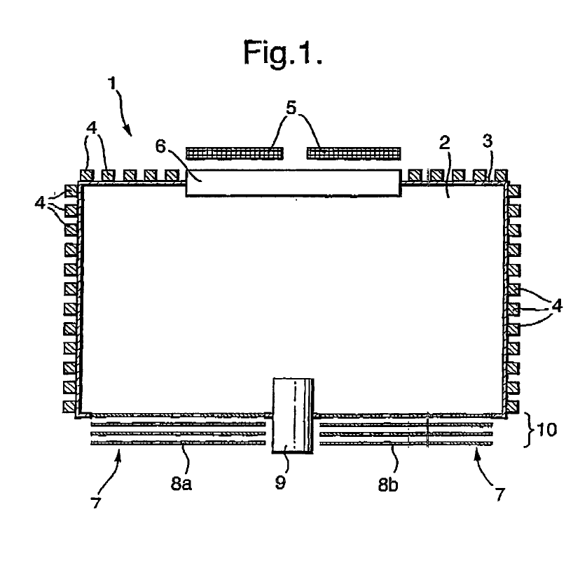

FIG. 1 is a diagrammatic section view of an ion source apparatus according to the present invention; and

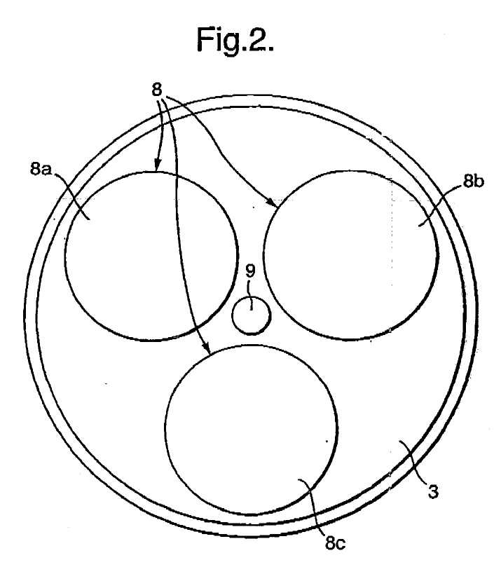

FIG. 2 is a diagrammatic front view of the apparatus of FIG. 1.

All references made herein to orientation (eg. top, bottom, front and back) are made for the purposes of describing relative spatial arrangements of the features of the apparatus, and are not intended to be limiting in any sense.

It will be understood by those skilled in the art that the drawings are merely diagrammatic and that further items of equipment such as vacuum pumps, control valves, pressure sensors, flux shapers and the like may be required in a commercial apparatus. The position of such ancillary items of equipment forms no part of the present invention and is in accordance with conventional practice in the art.

Referring to the drawings and particularly to FIG. 1 thereof, there is shown an ion beam generation apparatus for the generation of a plurality of ion beams, generally designated as 1. The apparatus 1 comprises a discharge chamber 2 which encloses a common plasma volume. The chamber is typically maintained at a pressure in the range of from about 10⁻⁵ millibar (about 10⁻⁴ Pa) to about 10⁻³ millibar (about 10⁻² Pa). Discharge chamber 2 is defined by plasma confinement vessel 3, about the periphery of which is arranged multi-polar magnetic means 4 for trapping ions which are released as a result of plasma formation within discharge chamber 2. The magnetic means 4 will generally comprise a plurality of bar magnets. In one arrangement a plurality of relatively long bar magnets are of alternating polarity in which the N,S cycle is generated in one axis only may be used. In an alternative arrangement, the “chequerboard” arrangement may be used where shorter magnets in which the N,S cycle is propagated in two orthogonal axes is used.

r.f. coil means 5 supplies r.f. power to discharge chamber 2, via dielectric r.f. power coupling window 6 which is set into the back wall of plasma confinement vessel 3.

The front wall of plasma confinement vessel 3 comprises three facets 8a, 8b and 8c (in FIG. 2) each including extraction means 7 for the extraction of ions from a plasma formed within discharge chamber 2 and acceleration of the ions out of the plasma confinement vessel 3 in the form of ion beams. Ion extraction means 7 comprises a plurality of composite grid structures. Each grid structure 10 comprises a plurality of multi-apertures grids in close proximity to each other, as described in WO98/18150. Thus a plurality of ion beams may be emitted from each ion extraction means 7 to form an ion beam column. Each facet 8 is situated on a pivoting mount (not shown) which allows angular alignment of the ion beam emitted therefrom. Therefore, the shape and direction of the column of ion beams may be manipulated by adjusting the angular alignment of each individual ion beam.

When a plurality of facets 8 are arranged in the front wall of plasma confinement vessel 3, there is a naturally occurring redundant space at a central point between the facets 8. A neutraliser 9 is located in the front wall of plasma confinement vessel 3. Neutraliser 9 provides a supply of electrons to the surface of the target. The neutraliser may be placed in any position relative to the plurality of facets 8, however, it is preferable that it is positioned such that the beam of electrons is emitted within the boundary of the columns of ion beams emanating from facets 8.

When ion beam generation apparatus 1 is in use in a vacuum sputtering apparatus a suitable gas, such as argon, is inlet to discharge chamber 2 via gas inlet means (not shown). A plasma is formed therefrom by supplying r.f. power to the gas from r.f. source means 5. Generally, the plasma is contained within discharge chamber 2. A portion of the plasma is in close proximity to the ion beam extraction means 7 of each facet 8a, 8b and 8c. Each ion beam extraction means 7 comprises a plurality of composite grid structures 10 which draw ions out of discharge chamber 2 into the grid 10 and accelerates the ions therethrough. By this means a plurality of columns of ion beams are directed out of the ion beam generation apparatus 1 towards a single sputtering target.

The method of this invention is particularly suitable for the production of filters described above.

1. Apparatus for the generation of a plurality of ion beams, comprising:
a discharge chamber, defined by a plasma confinement vessel, for generation of a plasma therein; and
a plurality of facets located on the discharge chamber, each facet comprising a respective acceleration and extraction means for extracting ions from the plasma in the discharge chamber in an ion beam.

2. Apparatus according to claim 1, wherein the accelerator has two facets to produce two ion beams.

3. Apparatus according to claim 1, wherein the accelerator has a least three facets to produce at least three ion beams.

4. Apparatus according to claim 1, wherein each facet includes an array of apertures such that each ion beam is made up of a plurality of beamlets.

5. Apparatus according to claim 1, wherein each facet is pivotably mounted on the discharge chamber.

6. Apparatus according to claim 1, including means by which each ion beam may be steered to illuminate a discrete area of the target.

7. Apparatus according to claim 1, including means by which each ion beam may be steered to illuminate an area of the target which abuts at least one area of the target illuminated by a further ion beam.

8. Apparatus according to claim 1, including means by which the ion beams are steered to illuminate overlapping areas of the target.

9. Apparatus according to claim 1, additionally including r.f. plasma generation means.

10. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 1, arranged so as to project the plurality of ion beams into the vacuum chamber so as to illuminate a respective area of the deposition target.

11. Apparatus according to claim 10 wherein the substrate table is rotatable and the apparatus includes means for rotating the substrate table.

12. Apparatus according to claim 10, additionally including a neutraliser.

13. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 1 so as to cause material to be sputtered from the deposition target; and
c) rotating the substrate while the deposition target is illuminated by the deposition target illuminating ion beams.

14. A method according to claim 13, wherein the thin film deposited on the substrate has a level of non-uniformity of at most ±0.01%.

15. Apparatus according to claim 2 wherein each facet includes an array of apertures such that each ion beam is made up of a plurality of beamlets.

16. Apparatus according to claim 3, wherein each facet includes an array of apertures such that each ion beam is made up of a plurality of beamlets.

17. Apparatus according to claim 2, wherein each facet is pivotably mounted on the discharge chamber.

18. Apparatus according to any one of claim 3, wherein each facet is pivotably mounted on the discharge chamber.

19. Apparatus according to claim 4, wherein each facet is pivotably mounted on the discharge chamber.

20. Apparatus according to claim 2, including means by which each ion beam may be steered to illuminate a discrete area of the target.

21. Apparatus according to claim 3, including means by which each ion beam may be steered to illuminate a discrete area of the target.

22. Apparatus according to claim 4, including means by which each ion beam may be steered to illuminate a discrete area of the target.

23. Apparatus according to claim 5, including means by which each ion beam may be steered to illuminate a discrete area of the target.

24. Apparatus according to claim 2, including means by which each ion beam may be steered to illuminate an area of the target which abuts at least one area of the target illuminated by a further ion beam.

25. Apparatus according to claim 3, including means by which each ion beam may be steered to illuminate an area of the target which abuts at least one area of the target illuminated by a further ion beam.

26. Apparatus according to claim 4, including means by which each ion beam may be steered to illuminate an area of the target which abuts at least one area of the target illuminated by a further ion beam.

27. Apparatus according to claim 5, including means by which each ion beam may be steered to illuminate an area of the target which abuts at least one area of the target illuminated by a further ion beam.

28. Apparatus according to claim 2, including means by which the ion beams are steered to illuminate overlapping areas of the target.

29. Apparatus according to claim 3, including means by which the ion beams are steered to illuminate overlapping areas of the target.

30. Apparatus according to claim 4, including means by which the ion beams are steered to illuminate overlapping areas of the target.

31. Apparatus according to claim 5, including means by which the ion beams are steered to illuminate overlapping areas of the target.

32. Apparatus according to claim 2, additionally including r.f. plasma generation means.

33. Apparatus according to claim 3, additionally including r.f. plasma generation means.

34. Apparatus according to claim 4, additionally including r.f. plasma generation means.

35. Apparatus according to claim 5, additionally including r.f. plasma generation means.

36. Apparatus according to claim 6, additionally including r.f. plasma generation means.

37. Apparatus according to claim 7, additionally including r.f. plasma generation means.

38. Apparatus according to claim 8, additionally including r.f. plasma generation means.

39. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 2, arranged so as to project the plurality of ion beams into the vacuum chamber so as to illuminate a respective area of the deposition target.

40. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 3, arranged so as to project the plurality of ion beams into the vacuum chamber so as to illuminate a respective area of the deposition target.

41. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 4, arranged so as to project the plurality of ion beams into the vacuum chamber so as to illuminate a respective area of the deposition target.

42. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 5, arranged so as to project the plurality of ion beams into the vacuum chamber so as to illuminate a respective area of the deposition target.

43. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 6, arranged so as to project the plurality of ion beams into the vacuum chamber so as to illuminate a respective area of the deposition target.

44. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 7, arranged so as to project the plurality of ion beams into the vacuum chamber so as to illuminate a respective area of the deposition target.

45. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 8, arranged so as to project the plurality of ion beams into the vacuum chamber so as to illuminate a respective area of the deposition target.

46. Vacuum sputtering apparatus capable of depositing multi-layer materials on a substrate comprising:
a vacuum chamber;
target support means within the vacuum chamber for supporting at least one deposition target;
a substrate table within the vacuum chamber for supporting a substrate oriented such that material sputtered from the at least one deposition target is deposited on the substrate when supported by the substrate table; and apparatus for the generation of a plurality of ion beams in accordance with claim 9, arranged so as to project the plurality of ion beams into the vacuum chamber so as to illuminate a respective area of the deposition target.

47. Apparatus according to claim 11, additionally including a neutraliser.

48. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 2, so as to cause material to be sputtered from the deposition target; and
c) rotating the substrate while the deposition target is illuminated by the deposition target illuminating ion beams.

49. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 3, so as to cause material to be sputtered from the deposition target; and
c) rotating the substrate while the deposition target is illuminated by the deposition target illuminating ion beams.

50. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 4, so as to cause material to be sputtered from the deposition target; and
c) rotating the substrate while the deposition target is illuminated by the deposition target illuminating ion beams.

51. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 5, so as to cause material to be sputtered from the deposition target; and
c) rotating the substrate while the deposition target is illuminated by the deposition target illuminating ion beams.

52. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 6, so as to cause material to be sputtered from the deposition target; and
c) rotating the substrate while the deposition target is illuminated by the deposition target illuminating ion beams.

53. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 7, so as to cause material to be sputtered from the deposition target; and
c) rotating the substrate while the deposition target is illuminated by the deposition target illuminating ion beams.

54. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 8, so as to cause material to be sputtered from the deposition target; and
c) rotating the substrate while the deposition target is illuminated by the deposition target illuminating ion beams.

55. A method of depositing multi-layer materials on a substrate by vacuum sputtering comprising:
a) providing a substrate supported by a rotatable substrate table and a deposition target within a vacuum chamber, the substrate table, the substrate and the deposition target being oriented relative to each other such that material sputtered from the deposition target is deposited on the substrate;
b) illuminating the target with a plurality of deposition target illuminating ion beams, from ion beam generating apparatus according to claim 9, so as to cause material to be sputtered from the deposition target; and
c) rotating the substrate while the deposition target is illuminated by the deposition target illuminating ion beams.
